(19) United States
(12) Patent Application Publication
(10) Pub. No.: US 2011/0062780 A1
(43) Pub. Date: Mar. 17, 2011

(54) POWER DISTRIBUTION UNIT WITH SUPPORT FOR HUMAN INTERFACE AND COMMUNICATION

(75) Inventors: Christopher Eugene VERGES, San Carlos, CA (US); Gregory A. REYNOLDS, Saratoga, CA (US); John DOVALA, San Jose, CA (US)

(73) Assignee: CYBER SWITCHING, INC., SAN JOSE, CA (US)

(21) Appl. No.: 12/561,267

(22) Filed: Sep. 17, 2009

(51) Int. Cl. H02J 3/00

(52) U.S. Cl. 307/38

(57) ABSTRACT

A power distribution unit (PDU) is disclosed wherein the PDU includes an interactive display and communications capability. The display is interactive. A touch screen allows a user to make selections of data, commands, and modes to view, as well as enter commands. Some versions include audio and video capability, allowing two people from distant locations to interact. Ports for USB, Ethernet, wifi, Bluetooth provide for various methods of interconnectivity. An energy metering and control board controls each PDU outlet and measures many parameters related to the power of each outlet. The data obtained is used to calculate the power of a three phase power source using no other hardware resources.

### CROSS REFERENCE TO RELATED APPLICATIONS

This application is related to commonly-owned U.S. patent application Ser. No. 12/177,881 submitted Jul. 22, 2008, by Christopher Verges, which application is incorporated herein in its entirety.

### BACKGROUND

Our society is using more and more electrical power for consumer electronics devices and even charging automobiles. So too, as private individuals and companies make growing use of the internet and other communications means, infrastructure facilities such as server farms and collocation facilities continue to use more electrical power with ever increasing complexity. The electrical needs of such facilities are often met using power distribution units (“PDUs”).

This increased complexity is leading to more automation as a solution for managing power and dealing with installation and with problems, such as load balancing, load shedding, time of day and day of week scheduling, and problem avoidance and resolution. However human interaction with such systems is still required. This is somewhat frustrated by the counter forces of increasingly concentrated command and control but far reaching, geographically diverse power consuming centers. Users request more features, including more information from PDUs, a product which historically is relatively “dumb.” For example, users want to monitor power usage by individual outlet, thereby enabling assignment of cost on a per-user basis. Ideally the data should enable a determination of the total power taken from the grid, taking into account the various phases. The present art sometimes provides such information, but at a significant cost for the hardware to do so.

In addition to the overall higher energy usage in datacenters, many facilities are now shared by multiple organizations. Colocation facilities, for example, are datacenters where disjoint parties locate their equipment, with the facilities infrastructure itself being run by a common third party. Corporate datacenters also are seeing a trend towards sharing datacenter resources across multiple business units. Yet with both scenarios, for management and billing purposes, energy usage must be allocated to each party or business unit. The classical model of having a single power meter at the building ingress does not lend itself to tackling this challenge.

Because of the high number of devices being placed on the power grid's edge, it seems appropriate to have an equal number of meter devices. However, the classical meters are too expensive and cumbersome to install for each device in a datacenter. Instead, the power strip (a.k.a. “power distribution unit” or “PDU”) has been tapped with that task.

What is needed is the addition of improved local human interfaces for monitor, control, intervention, and installation activities as well as human to human connectivity for these same purposes. Such a system should also provide improved information at a reasonable cost.

### SUMMARY

The present invention comprises equipment and methods which enable humans to better monitor system conditions in real time, either at the point of interest or remotely. In addition, the present invention provides for system command and control, including override, as well as communication between a person and remote equipment and between two or more persons.

The present invention comprises communications and display capability in conjunction with power distribution units, utilizing many of today's communications means such as local area network, wifi, USB, RS-232, and Bluetooth to name a few. Such communications then provide the ability to logically combine physically diverse resources into virtual power distribution units, enabling a higher logical level of control. Virtual power distribution units (“VPDUs”) were disclosed in aforementioned U.S. patent application Ser. No. 12/177,881 and are not repeated in this application.

The present invention also includes local displays for providing certain information to a human observer and enabling complex control commands. Displays plus sensors, such as a camera or microphone, enable the remote operation and/or verbal communication between two or more persons. Some displays also provide means for a person to request certain data and/or to enter requests, commands, or setup values for action by the system. In some embodiments individual and collective power use is also available for display or remote collection. Calculations based upon raw data enable these determinations without adding additional electronic components.

### BRIEF DESCRIPTION OF THE DRAWINGS

FIG. 1 is a level block diagram of an example system.

FIG. 2 is one example of daisy chaining power distribution units using various communications means.

FIG. 3 is an example of a display for local command and control input.

FIG. 4 is a flow chart of logical steps for local command and control, using the display of FIG. 3.

FIG. 5 is an example of power data presented on a local display.

FIG. 6 is an example of a graphic data presented on a display.

FIG. 7 is an example of a process for a user setting up system parameters using a touch sensitive display unit.

FIG. 8 is an example of an alert message provided by a panel on a power distribution unit according to the present invention.

FIG. 9 is an example of log information regarding a power distribution unit as presented on a local display.

FIG. 10 is a flow chart of the logical steps for presenting and providing response capability regarding a system alert.

FIG. 11 is an example of a system within a power distribution unit providing real time audio and video communication between two technicians involved with trouble shooting a power distribution system.

FIG. 12 is an example of a system within a power distribution unit providing real time text communication between two technicians involved with trouble shooting a power distribution system.

FIG. 13 is a schematic of an energy metering and relay control board.

FIG. 14 is a schematic of a bank assembly including a plurality of energy metering and relay control boards similar to the board of FIG. 13.

FIG. 15 is a schematic of a system formed from a plurality of bank assemblies similar to FIG. 14, including communication, display, and control elements.

FIG. 16 defines the orientation parameters used by a sensor algorithm for determining the orientation of a power distribution unit.

FIG. 17 is an illustration of a power triangle, showing the relationship between real, reactive, and apparent power.

FIG. 18 illustrates the sum of electrical outlet apparent power vectors forming a bank apparent power vector.

FIG. 19 is a schematic of a three phase Delta and Wye circuit.

FIG. 20 shows the phase shift of three phase voltage waves.

FIG. 21 is a three phase Wye circuit.

FIG. 22 defines the phase relationships and symbols used in analyzing a three phase Wye circuit.

FIG. 23 is a three phase Delta circuit.

FIG. 24 defines the phase relationships and symbols used in analyzing a three phase Delta circuit.

FIG. 25 shows the interaction of three phase Wye and Delta circuit waves.

FIG. 26 is a flow chart of logical steps in determining and displaying input power parameters to an observer.

### DETAILED DESCRIPTION OF THE INVENTION

### Definition of Some Terms

| | |
|---|---|
| ADC | Abbreviation for Analog to Digital Converter. |
| Bluetooth | An open wireless protocol for exchanging data over short distances with |
| | fixed and mobile devices, thereby creating a personal area network. |
| GUI | Graphical User Interface. A visual presentation enabling a human user to |
| | visualize and control a physical asset, such as a computer or a controller |
| | controlling an outlet in a PDU. |
| I/O | Input/output. A term referring to how many input or output pins a |
| | device provides. |
| LAN | Local Area Network. A computer network covering a small local area. |
| LCD | Liquid Crystal Display. A low power display technology. |
| NIC | Network Interface Card. An electronic circuit providing LAN connectivity to |
| | an electronic appliance such as a computer or a PDU. |
| OS | Industry standard term for the operating system of a computing device, |
| | such as a PC. |
| Outlet | A mechanical port to which a load may be connected. The load may be |
| | an electrical appliance or a branch to another outlet or a plurality of |
| | outlets. A load may be removable (unplugged) or hard-wired. Sometimes |
| | called a “power terminal”, “electrical outlet”, “power outlet” and other |
| | similar terms. |
| PC | Personal Computer. |
| PDU | Industry standard term for a power distribution unit. A PDU has electrical |
| | outlets that may be turned ON or OFF. |
| QVGA | Quarter Video Graphics Array. A computer-like display with 320 × 240 |
| | pixel resolution. |
| TRX | Industry standard abbreviation for a transceiver. |
| USB | Universal Serial Bus, a serial communications technology standardized by |
| | the USB Implementers Forum (USB-IFP). |
| VPDU | A virtual PDU. Sometimes referred to as a “logical PDU.” |
| wifi | Wireless local area network, based upon unlicensed spread spectrum |
| | technology. |

The present invention provides for human interface displays embedded within a power distribution unit. The display presents predetermined information, and in some embodiments includes the ability for a user to input data or commands, request certain information, or change configurations. Some embodiments include electronic communication such that two or more PDUs may be logically combined, thereby forming a virtual power distribution unit. In some embodiments the electronic communication capability is used to transport video, audio, status, control, or other information between two or more PDUs and/or a PDU or VPDU to a remote location. These communications are real time, such that system personnel may communicate to each other for the purposes of repair, troubleshooting, installation, configuration, and other obvious uses.

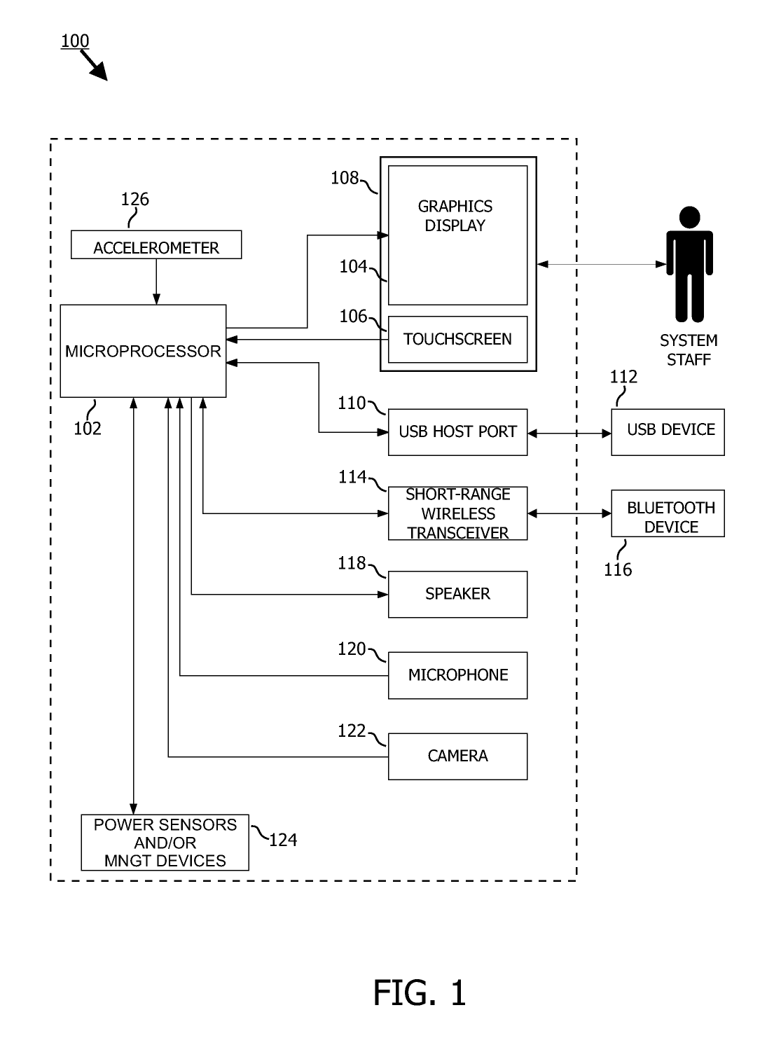

Looking to FIG. 1, the dotted line defines those elements of the present invention 100 that are enclosed within a subject PDU. A given PDU may have all or less than all of the elements shown. An exemplary embodiment of the present invention 100 includes a microprocessor 102. A microprocessor 102 controls the functions, including control, display, communication support, data collection, user interface, and calculations as needed. In some embodiments the microprocessor 102 includes sensors, for example a temperature sensor or an analog-to-digital converter. The microprocessor 102 may display information on a display 104. In some embodiments the display 104 is a quarter VGA (QVDA). Other embodiments include a custom LCD display with predetermined symbols, an LCD module with alphanumeric capability, dot matrix LCDs or LEDs, or a panel with LEDs at certain positions associated with predetermined status words. In the interest of completeness this disclosure will assume a QVGA display, though a system including other display types is within the scope of the present invention.

The microprocessor 102 receives user input from a touch screen 106. In some embodiments the touchpad 106 is a keypad, slew switches, or positional switches. In one embodiment the touch screen 106 is transparent and is physically in front of the display 104 forming a single display and input unit 108. A single unit 108 enables the dynamic display of selectable information or modes which a user may then touch to select.

In some embodiments the microprocessor 102 is connected to a USB host port 110 for receiving or sending signals to a supported USB device 112. Examples of USB devices 112 a video camera, digital camera, microphone, sensor data port, and others that are well known.

In some embodiments the microprocessor 102 connects to a short range wireless transceiver 114. Such transceivers 114 are often based upon the Bluetooth technology. The transceiver 114 communicates wirelessly with a wireless device 116, such as a Bluetooth video camera, digital camera, microphone, or other sensor or interface device.

The microprocessor 102 may be connected to a speaker 118, thereby providing warning or status noises or prerecorded announcements. The speaker 118 may also carry audio from another person or annunciation element outside of the instant PDU via PDU-to-PDU communication, to be discussed hereinafter.

The microprocessor 102 may be connected to a microphone 120 for receiving audio from a user. The microprocessor 102 may also be connected to a camera 122. In some embodiments the camera 122 is a video camera, in other embodiments the camera 122 is a digital camera. The microprocessor 102 is connected to one or more power sensors and/or power management devices 124 for control or parameter sensing of the power outlets within the PDU (not shown). Multiple sensor or management devices are sometimes connected together and share or pass on data, forming a bank of such devices.

Some embodiments include an accelerometer 126 for sensing the orientation of the PDU. Determining the orientation of the PDU allows the microprocessor 102 to orient the display on the graphics display 104 appropriately. In other embodiments, wherein the accelerometer 126 is not included, the system provides means for a user to select a display orientation.

The connections to the various elements 104, 106, 108, 110, 114, 118, 120, 122, 124, 126 of the system 100 to the microprocessor are appropriate for the electronic interface of the individual element. The microprocessor 102 may include all of the electronic interfaces needed for a given complement of peripheral elements, or the microprocessor 102 may further have various external interface circuits to provide the needed interface. The connections are not discussed here, in that one of ordinary skill would be able to provide the appropriate interface.

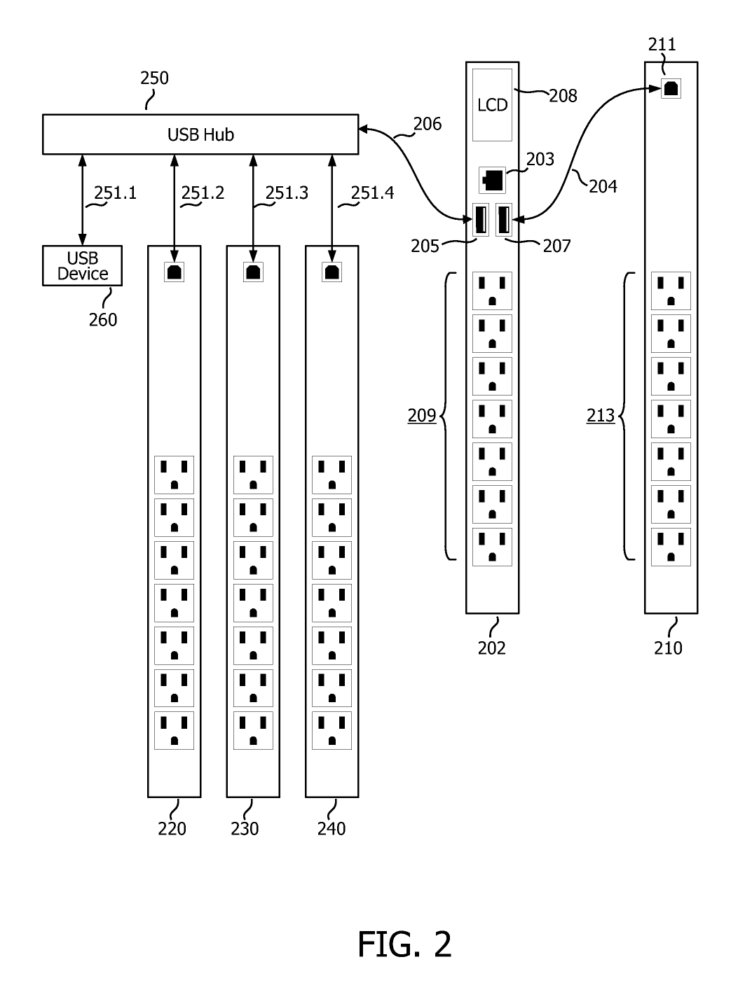

Looking to FIG. 2, a PDU 202 comprises a display and touch screen device 208 similar to the display 108 of FIG. 1; a LAN connector 203 (not used in this example), two USB-A connection ports 205, 207 and a number of power outlets 209. A second PDU 210 includes a USB-B port 211. A USB A-B cable 204 connects the second PDU 210 with the first PDU 202. Once the second PDU 210 is connected to the first PDU 202 the outlets of the second PDU 210 may be “seen” by the microprocessor 102 (FIG. 1) of the first PDU 202. In some embodiments the outlets 213 of the second PDU 210 are controlled by the microprocessor of the first PDU 202 and/or information associated with the PDU 210 and/or its individual outlets 213 presented on the display 208. In embodiments wherein the display 208 includes a touch screen for control, a user may enter commands regarding an individual outlet amongst the complement of outlets 213 of the second PDU 210. Of course such control would also be available amongst the outlets of the first PDU 202.

In similar fashion a second USB-A port 205 enables connection to a USB hub 250, thereby providing connection to one or more PDUs 220, 230, 240 wherein the PDUs 220, 230, 240 include USB-B ports for connection using USB-AB cables 251.2 to 251.n, wherein “n” indicates the number of USB equipped PDUs connected to the USB hub 250. The hub may also provide for a connection to a non-PDU peripheral device 260 via USB-AB cable 251.1. The non-PDU peripheral device 260 may, for example, be a camera, temperature sensor, or any other USB-equipped electronic device. As with the PDU 210, the additional PDUs 220, 230, 240 may be logically controlled by the first PDU 202 to form a virtual PDU, as disclosed in detail in the aforementioned Verges '881 application. In some embodiments the first PDU 202 provides display or control functions for it's USB-connected sister PDUs, but a virtual PDU is not formed.

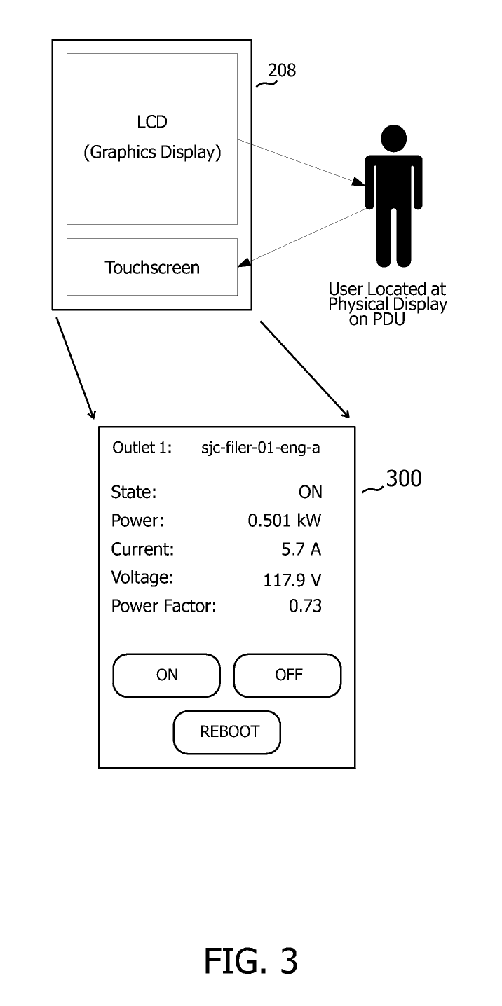

FIG. 3 is an example of how a user may receive information regarding a given physical or logical (eventually physical) outlet. For example, assume the touch screen 208 corresponds to the touch screen 208 of the first PDU 202 of FIG. 2. The display in the example provides identification, state, power, current, voltage, and power factor plus includes user input to turn the selected outlet ON, OFF, or to REBOOT it. REBOOT is a two step process of cycling outlet OFF, then back ON. Of course more, less, or different information may be provided on the screen 208. The outlet of interest may be selected remotely from a central facility or may be selected based upon out of specification performance. In one embodiment a selection screen (not shown) is presented enabling the user to select the outlet of interest.

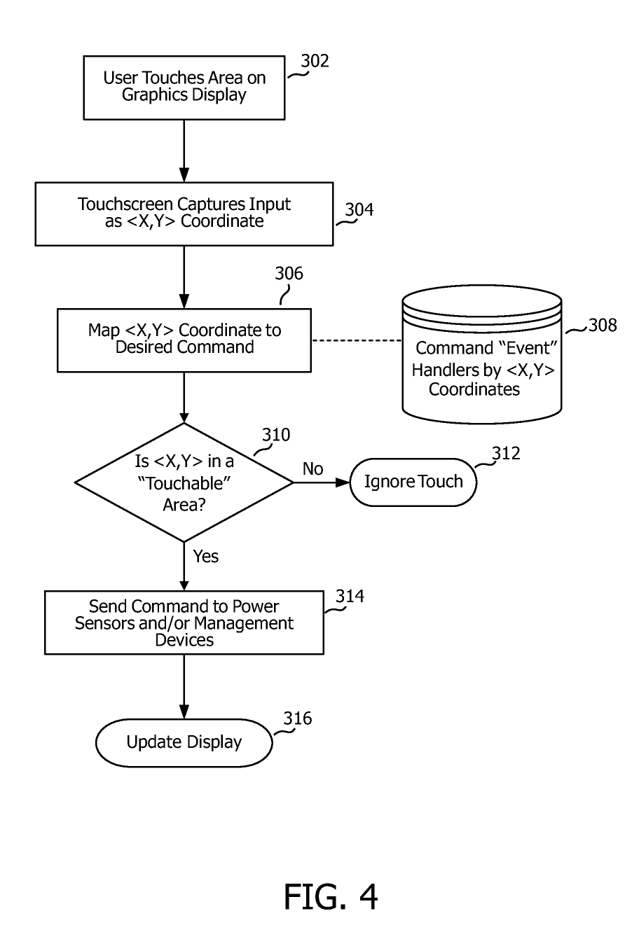

Referring to FIG. 1 to understand the supporting elements, FIG. 4 is an example of a flow chart of the logic for controlling the display 108 and an associated outlet or device. A user touches 302 the display 108. A touch screen 106 captures the input and provides X,Y coordinates 304 to the microprocessor 102. The microprocessor compares the X,Y coordinates 306 with a map of coordinates that correspond to commands 308. The command handler 308 has a library of command responses. One of the responses from the command handler 308 is the return that the area touched was not a touchable command area. That is, the area touched was not a “button” defined on the graphics display 104, which is tested for at step 310. If the touch was not in a valid area, the touch is simply disregarded 312 and the process again waits for a touch 302. If the touch was within a valid area the event handler has provided the microprocessor with instructions, which the microprocessor puts into action in response to the decoded command 314, then updates the display accordingly 316, and returns to waiting for a new touch 302.

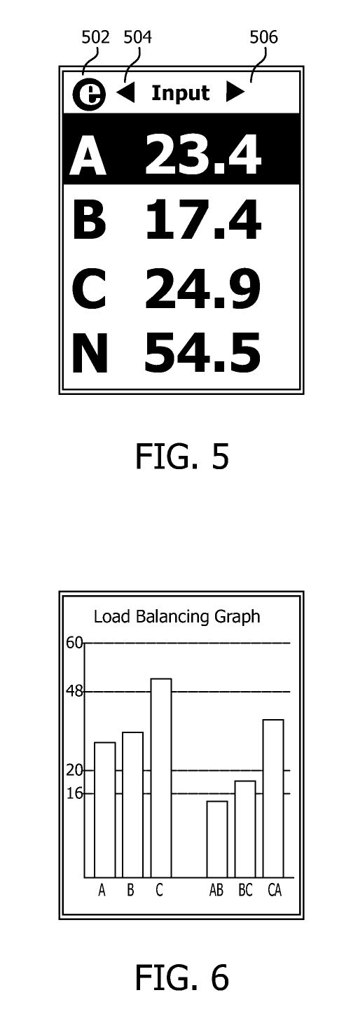

FIG. 3 is just one example of the data that a screen 108 may display. FIG. 5 is an example according to FIG. 3 wherein the input current in each phase and the neutral line of a three-phase Wye power input cord is shown. The information displayed is sometimes rotated amongst various predetermined presentations, changing every few seconds or in response to an event. In one embodiment a touch area 502 allows a user to interrupt the sequence, or to manually advance to the next screen. Arrows 504, 506 may also be used to enable navigation.

FIG. 6 is another example of a data display. Sometimes the screen 108 supports color, including color graphics.

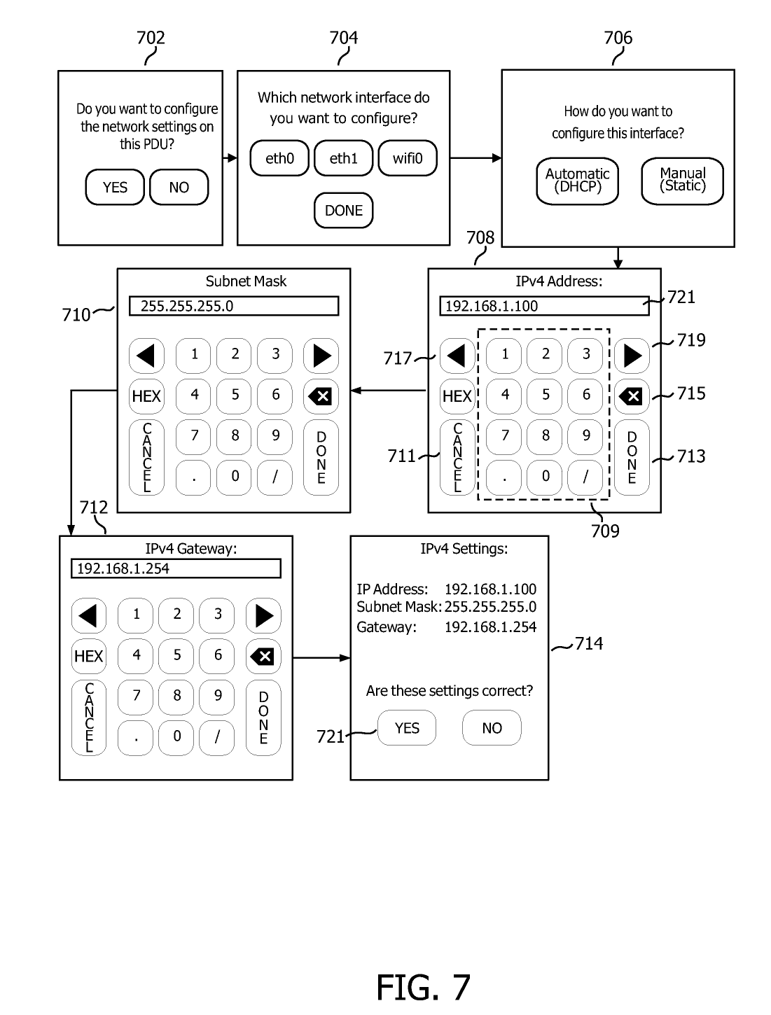

In another example following FIG. 3 (with element references to FIG. 1), FIG. 7 shows an example process of setting up the LAN settings of a PDU upon installation. FIG. 7 is a sequence of questions, input enablement layouts, and example user inputs on the touch screen 108. After getting into this configuration mode (not shown) the user is asked 702 if he wants to configure the instant PDU. Assuming a “YES” response, the user can select which LAN to be configured 704. In this example there are two Ethernet and one wifi network selectable. Assuming ETHO was selected, the user is next asked to select between DCHP or manual setup 706. In either case an IPv4 address is assigned (DCHP) or entered (manual) 708. Manual entry is done using the keypad 709. Once an IPv4 address is shown 721, the user may cancel the entry 711 and try again; indicate “DONE” 713; navigate to the next 717 or previous 719 screen, or delete the previous character 715.

When the user touches the DONE area 713 the next screen allows entry of the subnet mask 710 in the same manner as the IPv4 address. The next step is to configure the IPv4 gateway 712, then a summary of all configuration data is shown 714. The user confirms “YES” 721 that the data entered is correct, the data is stored, and the system returns to step 702. If the user responds with “NO” at step 714 the data is not saved prior to the system returning to step 702.

As has been seen, the use of a display screen 104 by the microprocessor 102 provides convenience and time savings as well as lower cost by enabling technicians to receive information and make responses where they are, without the need for a computer console, etc. Of course the display could be related to a PDU that is remotely located from the user; the display is at the PDU the user is using at the instant time.

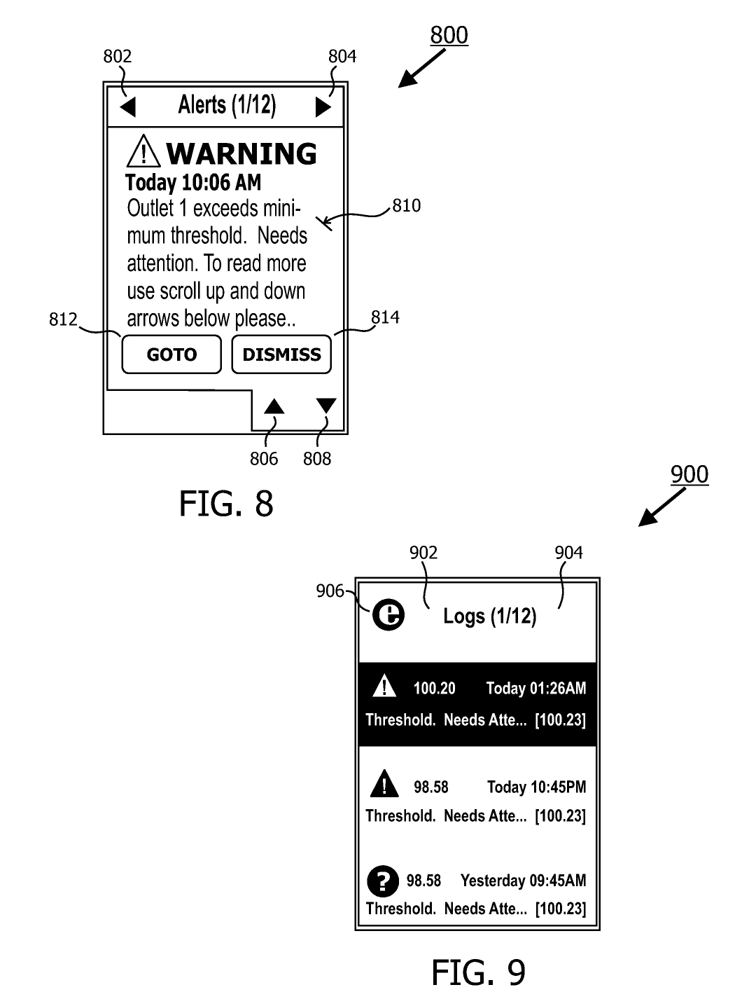

In another embodiment the system is designed to provide trouble alerts that override any other information of the moment (including none). For example, FIG. 8 is an example of an alert message 800. LEFT 802 and RIGHT 804 arrows allow the user to step through a list of alerts 800. A message area 810 gives the reader information and sometimes instructions. A GOTO button takes the user to additional information and/or instructions. A DISMISS button 814 removes the alert from the alert list. In some embodiments an alert dismissal requires the user to enter a password that identifies him as having the authority to dismiss the alert. UP 806 and DOWN 808 arrows provide for scrolling the display to make additional text area available.

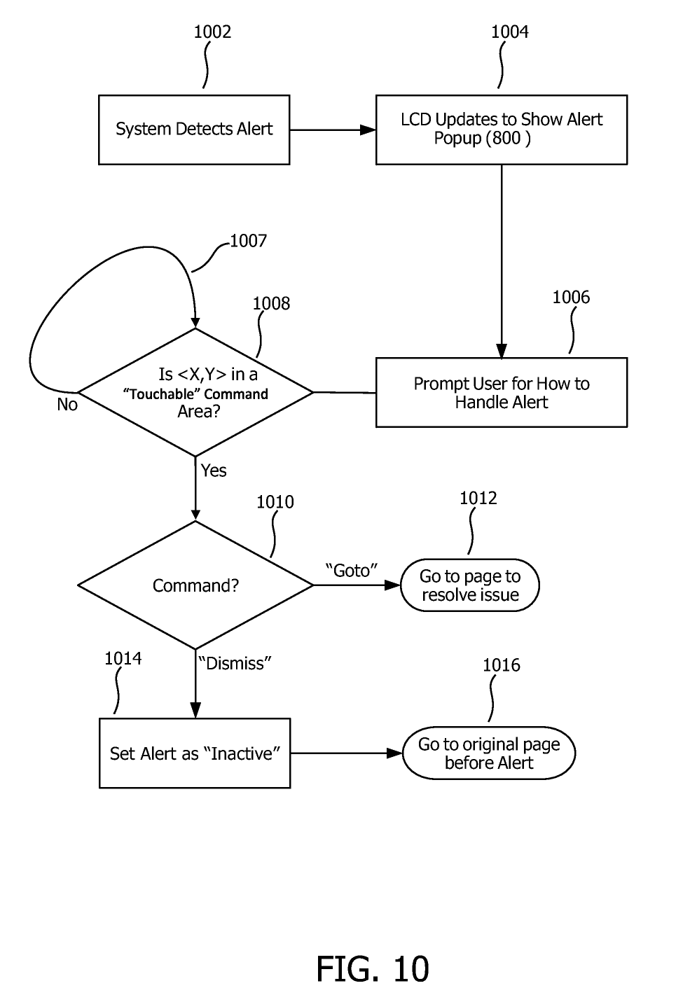

FIG. 10 is an example of a flow chart illustrating the logical steps in support of alert displays. When the system detects an alert condition 1002, the display (local or remote or both) updates to “pop up” the alert message 800, overriding whatever else may have been previously displayed. The user is prompted for a response 1006, which response is tested 1008, looping until the touch is in a valid area 1007. In this example only two command responses are allowed 1010, other designs may allow more or different rezones. If the command GOTO is touched 1012 control passes to an appropriate page/procedure for response. If the user dismisses the alert 1014, the alert changes to “Inactive” status and control/display return to the previous (pre-alert) condition 1016.

Similar to alerts, FIG. 9 is an example of a display of a log of activities 900. LEFT 1002 and RIGHT 1004 arrows enable stepping from one log page to another. An input area 906 may allow stepping to the next or previous log item.

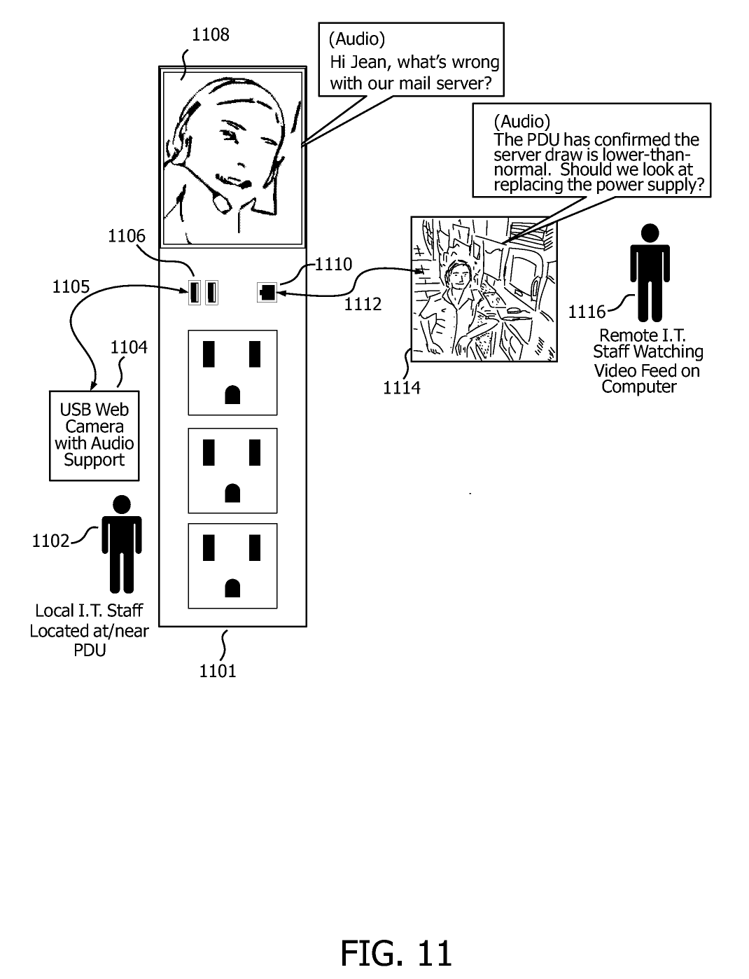

FIG. 11 is an example of audio and video links between two remotely located staff members enabling problem resolution. In a theoretical scenario, a staff member 1102 is located near a PDU 1101, wherein the PDU 1101 is part of a system equipped according to the present invention. A video camera with audio support 1104 is connected to the PDU 1101 via a USB cable 1105 to a USB port 1106 on the PDU 1101. Of course, as previously discussed, the video and audio support could connect to the PDU 1101 via a LAN connection, or the video camera and microphone could be built into the PDU 1101 (not shown). The video and audio feed is, for example, communicated to a remote staff member 1116 via a LAN connection 1110 through a LAN cable 1112, the LAN cable 1112 further connected (directly or through an Ethernet connection) to a monitor 1114 at the remote location where there is a problem. Of course the monitor 1114 could be the screen of a PDU at the remote location, wherein the remote PDU is also equipped according to the present invention. Video and audio from the remote location is delivered via the same LAN connection 1110 back to the PDU 1101 and is presented to the local staff member 1102 on the screen 1108 of the PDU 1101. From this and the previous description other configurations for communication will be obvious. The person in the display 1114 corresponds to the local staff member 110-2, and the person in the other display 1108 corresponds to the remote staff member 1116.

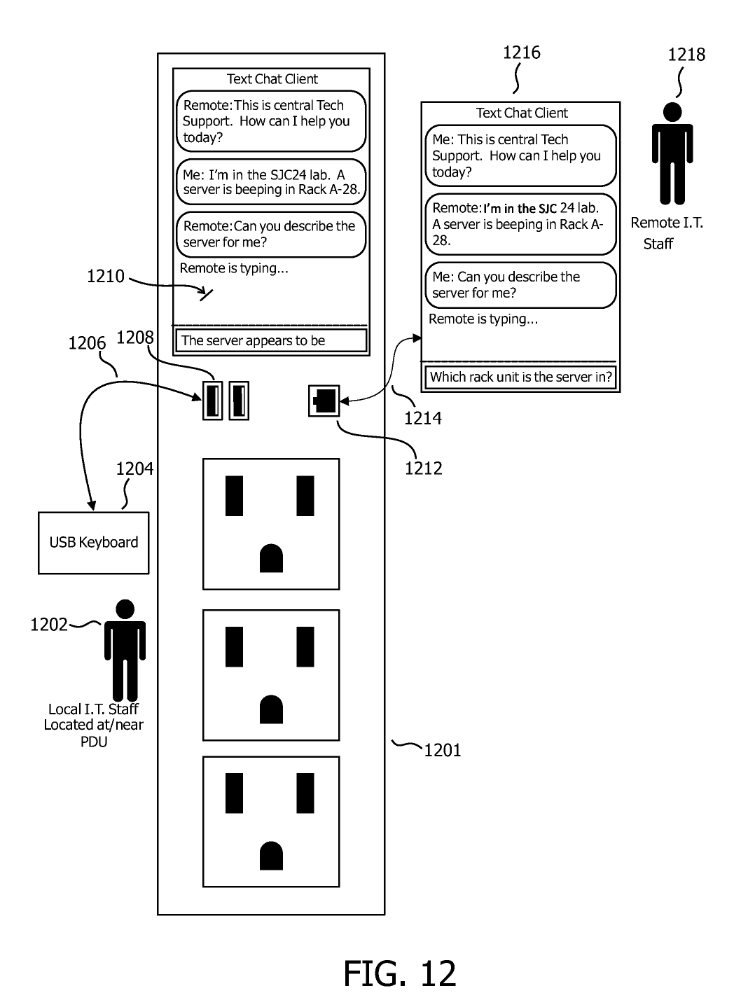

In a similar situation, an example illustrated by FIG. 12, communication between the two staff members 1202, 1218 is based upon text. The local staff member 1202 types a request using a USB keyboard 1204, wherein the USB keyboard 1204 is connected to a USB port 1208 via a USB cable 1206. The USB port 1208 is associated with a PDU 1201 that is equipped according to the present invention. The text typing of the first staff member 1202 and the second staff member 1218 is shown on the display 1210 of the PDU 1201. As previously discussed, text typing could also be done by presenting a keypad on the touch screen 1210 of the PDU 1201. Text is sent to and from a remote display 1216 through a LAN port 1212 connected by a LAN cable 1214, optionally through an Ethernet system. The display screen 1216 may be a standalone touch screen with the appropriate interface, or could be the screen on a PDU at the remote location.

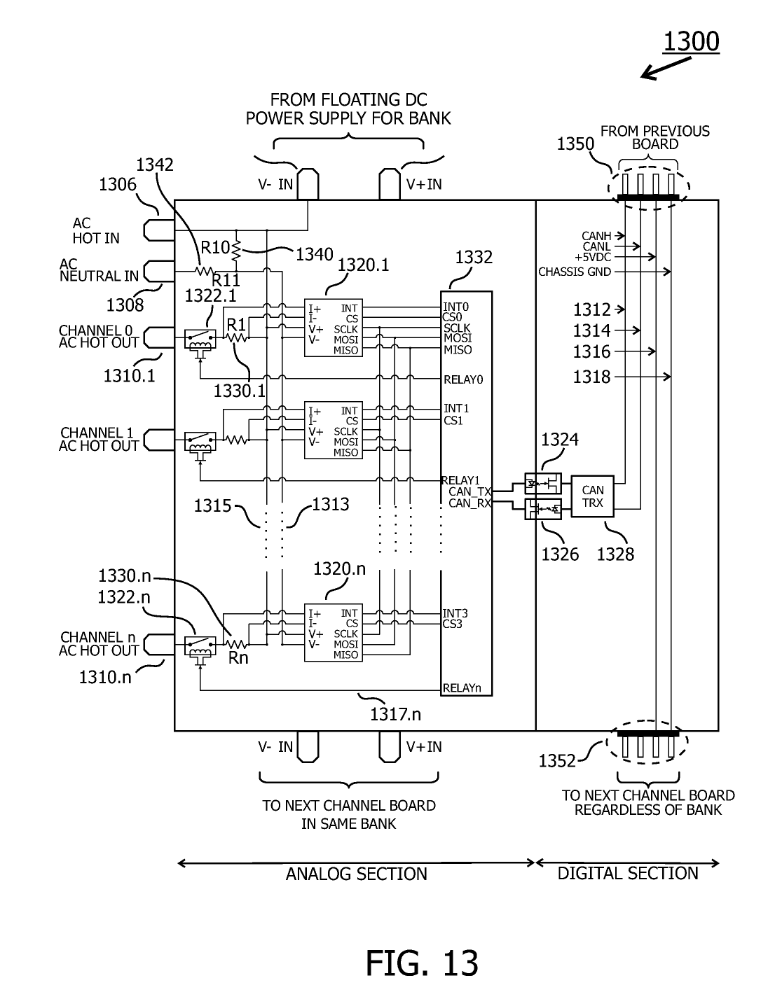

In some embodiments of the present invention a PDU includes the ability to collect and report parametric and performance data and to control one or more outlets. The data can be made available to a local user if a display is included in the local PDU, and to a remote user if communications is included. An example of support for this feature is the circuit of FIG. 13, an energy meter and relay control board 1300. As will be discussed later, energy meter and relay boards 1300 can be combined within a defined bank of PDUs, as well as communicate outside the instant bank.

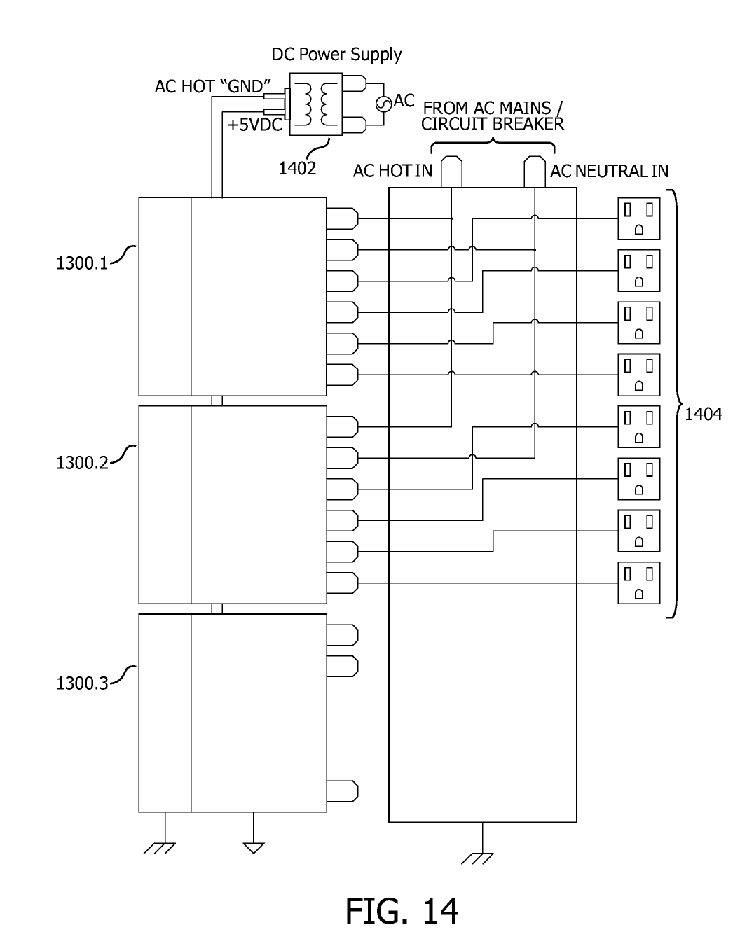

The board 1300 comprises two sections: an analog section and a digital section. The analog section comprises a floating DC power supply 1402 (FIG. 14) which provides DC voltage at pins V−IN 1302 and V+IN 1304. The power supply 1402 may receive any electrical power, AC or DC, providing it can then supply a constant DC voltage offset against the floating (AC) ground AC HOT IN. V−IN 1302 is an AC signal used as a relative (floating) ground, and V+IN 1304 rides at a constant voltage, for example +5 volts, on top of VI−IN. V+IN is provided to “n” number of integrated circuits 1320.n. Throughout this description we may use a reference number with “n” to mean any one or all such elements with the same reference number, but a different number for “n.” CAN controller 1332 and a CAN TRX 1328 have an isolated ground from V−IN. In FIG. 14 the voltage signal V−IN is marked as “AC HOT GND” to make clear it is AC. AC HOT GND/V−IN is connected to the positive electrical connector in common with the power outlets of the PDU by a line 1303 to the electrical terminal 1306 labeled “AC HOT IN”, forcing the two to the same electrical potential. AC HOT IN may be a nominal 120 VAC, 208 VAC, or other voltages standard in varying countries. Regardless the value of AC HOT IN (and thereby AC HOT GND and V−IN), V+IN will be five volts above it, thereby providing a five volt supply for the electronic components of the board 1300. Of course a different DC offset could be used to support an electronic design based upon other than five volts.

ICn 1320.n is an integrated circuit which measures outlet parameters, for example voltage, current, power, and apparent energy. An example of such a device is an ADE7763 Single-Phase Active and Apparent Energy Metering IC, available from Analog Devices, 3 Technical Way, Norwood, Me. One skilled in the art will know of other products suitable for the measurements, such as a standard microprocessor with ADC input with appropriate firmware. The ICn 1320.n has a maximum input range for ADC conversion, so we scale the neutral line AC NEUTRAL IN 1308 to a value close to that of AC HOT IN. Scaling is done using a resistor divider comprised of R10 1340 and R11 1342. For example, with AC HOT IN of approximately 170 volts (peak relative to neutral; typical of 120 volt RMS household current), R10 (1340)=1 Kohm, R11 (1342)=1 Mohm, the voltage on line 1313 will be approximately 0.1698 volts, well within the conversion range of the energy device ICn 1320.n.

AC HOT IN from terminal 1306 is distributed on a line 1315 and the scaled version of AC NEUTRAL IN from terminal 1308 is distributed on a line 1313. Lines 1313 and 1315 are provided to the inputs V− and V+ respectively of all ICn 1320.n devices. The CAN controller 1332 provides control of the process. Many microcontrollers with adequate I/O would be suitable for this purpose. The operation of Channel “n” will be described; the other channels are controlled in the same manner.

Assuming a given outlet connected to the Channel n AC HOT OUT terminal 1310.n is to be powered ON, CAN controller 1332 closes a SPST relay 1322.n by driving a control signal onto line 1317.n. Relay 1322.n connects the voltage on pin 1310.n to the I+ input terminal on ICn 1320.n. Current from pin 1310.n flows through a low value sense resistor Rn 1330 to the I− input terminal on the ICn 1320.n. The value of voltage across the sense resistor Rn 1330 is measured by ICn 1320.n, thereby determining the current by the formula

I=E/R

where “E” is the voltage measured across the sense resistor Rn 1330.n; and “R” is the value of the sense resistor Rn 1330.n. Sense resistor Rn is a low value, for example 0.005 ohm, to develop a low voltage in response to the current provided by its associated channel current. Of course other current sensing components may be used in addition or instead of a sense resistor.

The devices ICn convert the V+/V− input values to determine the voltage of the outlets in the PDU, taking into account that the V− value has been scaled down, again by the resistor divider formed by R10 1340 and R11 1342.

The board 1300 provides control and parameter measurements for an arbitrary number of outlets “n”, denominated as “n channels.” Each channel includes an electrical terminal 1310.n, a relay 1322.n, and a sense resistor Rn 1330.n or other current sensing device. FIG. 13 shows an energy measuring ICn 1320.n for each channel. In some embodiments there are fewer energy measuring ICs, each with more input terminals than shown in the example of FIG. 13. In some embodiments a MUX reduces the number of energy measuring ICs 1310.n. In the example of FIG. 13, each energy measuring IC 1320.n includes an interrupt pin INT, a chip select pin CS, a serial data clock SCLK, a shifted data output pin MOSI, and a shifted data in pin MISO. In this example using the aforementioned ADE7763 device, the ADE7763 device 1320.n continuously takes data. When data is ready the ADE7763 1320.n generates an interrupt on the pin INT. The CAN controller 1332 sometimes takes all data from all ADE7763 devices 1320.n, other times samples the data from each ADE7763 1320.n per a schedule. To receive the data from a given ICn 1320.n the CAN controller 1332 drives the appropriate chip select CS pin, then toggles the clock line SCLK and receives the data serially from the MOSI data out terminal. The ADE7763 device 1320.n may optionally be configured for certain parameters and operating modes by serially shifting in commands/data/flags by selecting the appropriate chip select CS pin, toggling the clock SCLK, and shifting in the data on the data input terminal MISO. MISO and MOSI are as shown in FIG. 13 rather than using the common terms for data input and output terminals to avoid confusion in that data “out” from a sender is date “in” to a receiver.

The CAN controller 1332 provides data to the CAN TRX 1328 from a signal terminal CAN_TX through an optical isolator 1324 (for safety reasons) and receives data from the CAN TRX 1328 at a signal terminal CAN_RX, again protected by an optional optical isolator 1326. The CAN TRX 1328 unit forms part of a system-wide CAN network on the digital section of the board 1300 by providing signals on the lines CANH 1312 and CANL 1314. The digital section also provides power on a DC line 1316 and a ground line 1318. Connectors 1350, 1352 provide interconnection means for connecting multiple energy meter and relay control boards 1300, thereby passing through bias voltage 1316, ground 1318, CANH 1312 and CANL 1314 signals to all boards 1300 so connected.

In some embodiments a plurality of energy meter and relay control boards 1300 are connected for form a larger local bank of control boards to support a larger number of outlets than a single energy meter and relay control board 1300 supports. An example of such a configuration is shown in FIG. 14, wherein three an energy meter and relay control boards 1300.1, 1300.2, 1300.3 are connected, powered by a single bias power supply 1402, managing the connections and collecting data for multiple outlets 1404.

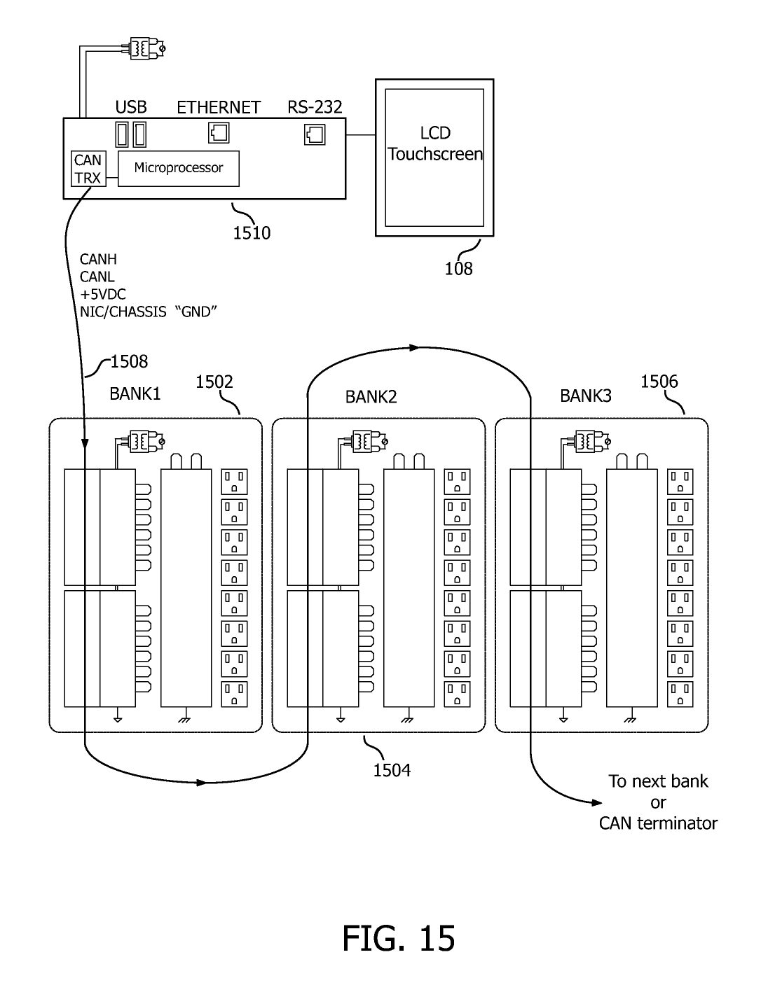

At a higher level of system integration, FIG. 15 illustrates an exemplary configuration of three banks comprising BANK1 1502, BANK2 1504, and BANK3 1506. Bias power, chassis ground, CANH and CAHL signals are provided to all of the banks 1502, 1504, 1506 by a common connection line 1508. The number of banks so connected is arbitrary. The connection line 1508 from the last bank in the system is connected to a CAN terminator. The connection line 1508 provides bi-directional CAN communications between the banks and a network interface card 1510. A network interface card 1510 can include a variety of connection means, for example USB, Ethernet, RS-232, Firewire, Bluetooth, and the like. Some central units also include a touch screen 108. In one embodiment the network interface card 1510 is incorporated into a PDU.

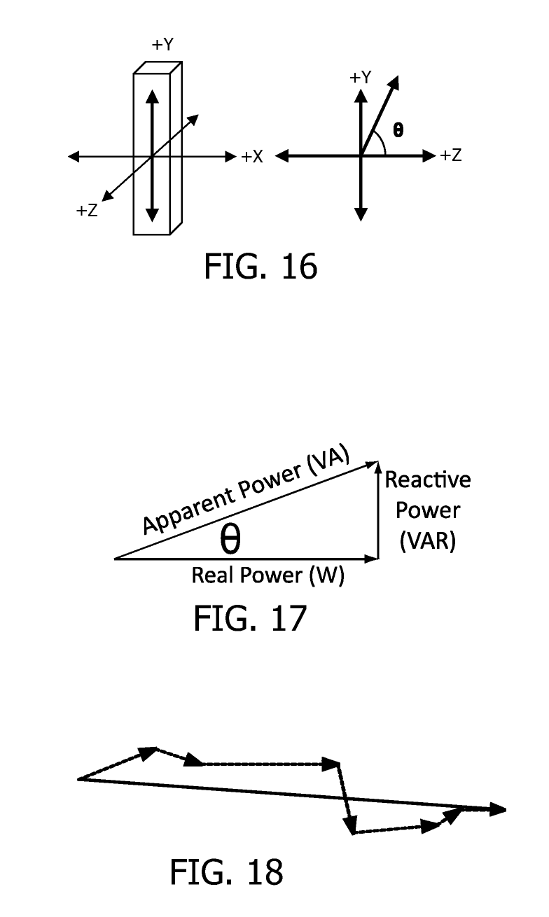

The description of the display 108 hereinbefore has assumed a vertical (portrait) orientation of the display 108. PDUs may be installed and used in any orientation. Some embodiments assume a static or user-selectable portrait display, others a static or user-selectable landscape display. In other embodiments, an accelerometer 126 is incorporated in a PDU according to the present invention. The accelerometer 126 provides means for determining the orientation of a PDU, thereby to present the data on the display 108 appropriately. FIG. 16 defines a three dimensional coordinate system and the rotation angle theta (θ) for the following explanation.

Define a relationship between θ and the display orientation:

45°<θ<=135°=UP

135°<θ<=225°=LEFT

225°<θ<=315°=DOWN

315°<θ<=45°=RIGHT

The gravity vector is read from the accelerometer 126, and the angle θ from the Y-Z plane determined. From the above relationships, we determine the orientation of the PDU. If the orientation is different than a previously stored orientation, the new orientation is saved as the instant “old” orientation and the display updated (that is, rotated) accordingly. Note that UP is defined as a vertical portrait orientation, and DOWN is an “upside down” version of UP. LEFT means that the landscape mode is counterclockwise relative to UP, and RIGHT means that the landscape mode is clockwise relative to UP.

In some embodiments the accelerometer 126 provides acceleration data that is used to detect an earthquake, violent weather, movement of a semi-permanent building, etc, and the microprocessor may then decide to shut down all electrical outlets for safety.

Per-outlet metering allows one to determine all energy parameters of both single phase and three phase systems. Each single phase load creates a unique power signature on the upstream distribution grid. By characterizing these power signatures, we can accurately predict the effects on the grid.

The discussion to follow focuses on the techniques involved in characterizing single phase loads connected to a three phase grid, since the challenges posed by such a setup are a superset of the single phase case.

A PDU acts as a junction point between a power grid and an edge device. Mathematical models describe the combined effects of the individual single phase loads on the grid itself, closing the loop and providing for an overall holistic approach to energy management.

In the this discussion we use the following terminology and symbolic convention:
\vec{P} is a vector named “P” with a given angle. The vector \vec{P} can be broken down into a magnitude P and an angle ∠θ.
φ is the phase shift (offset) between voltage waves in a three phase system.
θ is the phase shift (offset) between voltage and current waves in a single phase system.
The collective group of line-to-neutral phase angles (φₐₙ, φ_{bn} and φ_{cn}) will be referred to as φₗₙ where ln stands for “line-to-neutral.”
The collective group of line-to-line phase angles (φ_{ab}, φ_{bc} and φ_{ca}) will be referred to as φₗₗ where ll stands for “line-to-line.”
Similarly, any variable followed by a ln or ll subscript will refer to the line-to-neutral or line-to-line versions of the variable, respectively.
References hereinafter to a “bank” mean similar to a typical bank such as that of FIG. 14.

### Single Phase Fundamentals

Each single phase load is described by three components: the Apparent Power (S), the Real Power (P), and the Reactive Power (Q). The relationship between each is described in FIG. 17. Apparent Power is the power that the three phase distribution grid must generate to supply the single phase load. Real Power is the power that is actually consumed by the single phase load to perform the desired work. Reactive Power is the “overhead” (i.e. inefficiency) in the system for the given load. Equations (1), (2) and (3) mathematically describe this relationship.

RealPower(W)\vec{P}=VI cos θ=P∠0° (1)

ReactivePower(VAR)\vec{Q}=VI sin θ=Q∠±90° (2)

ApparentPower(VA)\vec{S}=\vec{P}+\vec{Q}=(V×I)∠0 (3)

Reactive Power cannot be measured directly, so most energy meters will measure Apparent Power and Real Power. Reactive Power can then be calculated by determining θ, the phase relationship between voltage and current waves.

An ideal situation occurs when |cos θ|=1. In this case, Real Power and Apparent Power are identical, and the Reactive Power is equal to zero; no power is wasted in the delivery of the energy itself.

Mathematically, the power components and current in a bank can be calculated. Note that in equation (7), the current for the bank is calculated by using the magnitude of the apparent power vector (\vec{S}) divided by the voltage of the bank.

\vec{P}Bank=Σᵢ₌₁ⁿ\vec{P}_{Outlet}_{_{—}}ᵢ=P_{Bank}∠0° 4)

\vec{Q}Bank=Σᵢ₌₁ⁿ\vec{Q}_{Outlet}_{_{—}}ᵢ=Q_{Bank}∠±π° (5)

\vec{S}_{Bank}=\vec{P}_{Bank}+\vec{Q}_{Bank}=S_{Bank}∠θ (6)

I_{Bank}=S_{Bank}÷V_{Bank} (7)

Since each outlet's \vec{Q} could be either positive (+) or negative (−) in direction, the total effect of the reactive power can either be constructive or destructive. For example, consider two outlets on a bank such that \vec{Q}₁=10∠+90° and \vec{Q}₂=10∠−90°. When both outlets are drawing power, their reactive powers are equal in magnitude yet opposite in direction. This effectively cancels the reactive power on the bank.

Due to this synergistic effect visualized in FIG. 18, the apparent power \vec{S} must be calculated using the individual vectors \vec{P} and \vec{Q} as described in equation (6). It may be found that the resulting vector \vec{S} has an improved power factor (cos θ).

### Three Phase Fundamentals

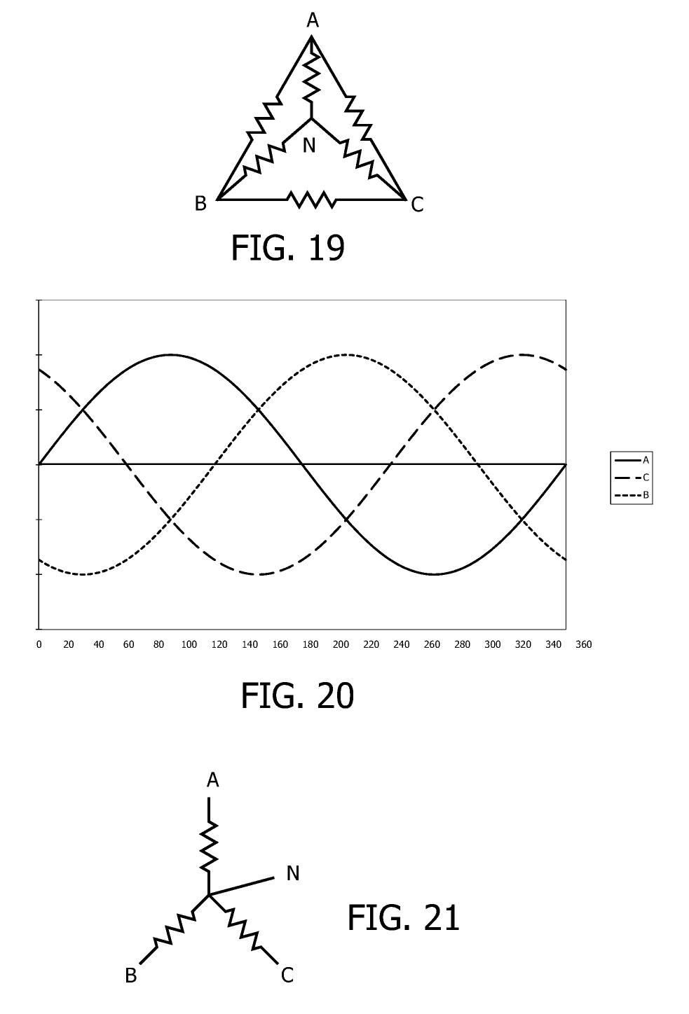

Three phase power circuits are of two types: Wye and Delta. Although similar in the power they provide, their analysis requirements are different. FIG. 19 shows a Wye and a Delta circuit superimposed to highlight the similarities and the differences. Three phase power is comprised of three separate AC waves that are phase shifted by 120 degrees and superimposed. Each wave is defined by equation (8):

f(t)=A sin(ωt+φ)) (8)

where

f(t) is the instantaneous voltage at a given time t,

A is the peak amplitude,

ω is the angular velocity given by 2πf,

f is the frequency (in Hertz), and

φ is the phase shift.

The relationship between these phases is shown in FIG. 20.

The set of line-to-neutral and line-to-line voltages can be described using vectors. For convention purposes, the phase shift of Vₐₙ is always equal to zero. Equations (9) thru (14) show both the mathematical definition as well as the ideal conditions (delineated by the operator ≈) for each equation.

$$\begin{matrix}\begin{matrix}{{V}^{->}}_{an} = {V}_{an} ∠ {φ}_{an} \\ = {V}_{an} ∠0°\end{matrix} & ( 9 ) \\ {{V}^{->}}_{bn} = {V}_{bn} ∠ {φ}_{bn} \approx {V}_{bn} ∠120° & ( 10 ) \\ {{V}^{->}}_{cn} = {V}_{cn} ∠ {φ}_{cn} \approx {V}_{cn} ∠240° & ( 11 ) \\ {{V}^{->}}_{ab} = {{V}^{->}}_{an} - {{V}^{->}}_{bn} = {V}_{ab} ∠ {φ}_{ab} \approx {V}_{ab} ∠30° & ( 12 ) \\ {{V}^{->}}_{bc} = {{V}^{->}}_{bn} - {{V}^{->}}_{cn} = {V}_{bc} ∠ {φ}_{bc} \approx {V}_{bc} ∠ - 90 ° & ( 13 ) \\ {{V}^{->}}_{ca} = {{V}^{->}}_{cn} - {{V}^{->}}_{an} = {V}_{ca} ∠ {φ}_{ca} \approx {V}_{ca} ∠ - 210 ° & ( 14 )\end{matrix}$$

In the United States, the typical line-to-neutral voltage is 120 VAC, resulting in a line-to-line voltage of 208 VAC. In many European countries, the typical line-to-neutral voltage is 230 VAC, with a corresponding line-to-line voltage of 400 VAC. The ratio between these voltage pairs is identical:

$$\frac{208 VAC}{120 VAC} = \frac{400 VAC}{230 VAC} = \sqrt{3}$$

Each single phase bank is connected to the three phase vectors in one of two ways: a Wye (line-to-neutral) or Delta (line-to-line) configuration.

### Three Phase Wye Circuits

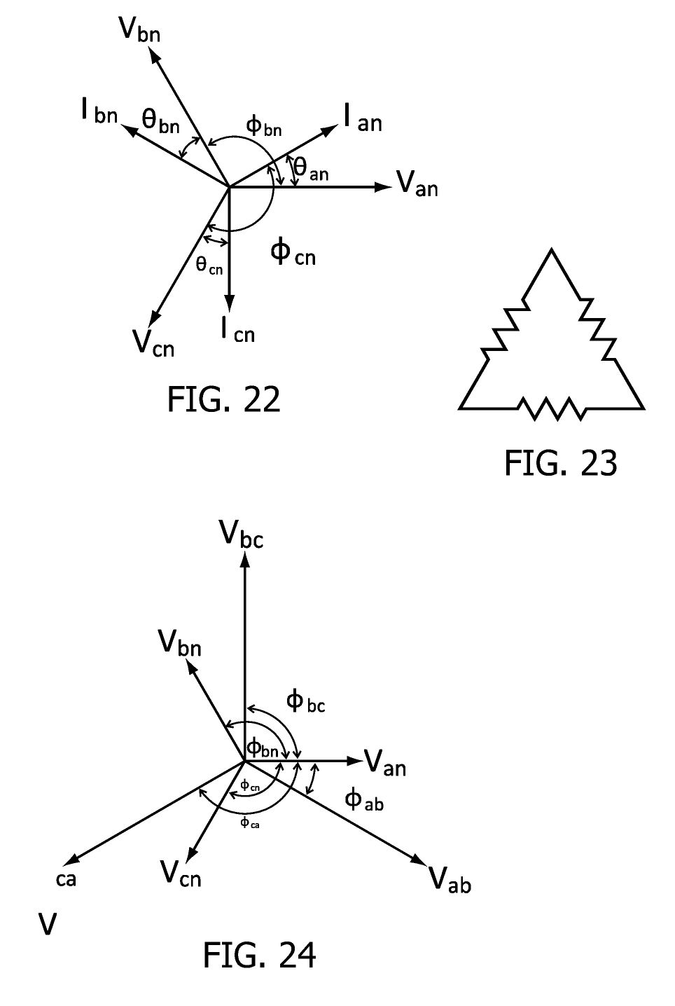

FIG. 21 shows a Wye circuit configuration, with the definitions of the various angles used in the following analysis shown in FIG. 22.

### Calculating the Line Currents

In a Wye system, each bank is connected between one of the lines (A, B or C) and neutral (N). For metering purposes, a Wye system is convenient, since simple vector math is adequate to determine the contribution of each bank to each line.

\vec{I}ₐ=Σᵢ\vec{I}_{Bank}_{_{—}}ᵢwhere the absolute∠θ′ₐ=φₐₙ+θₐₙ (15)

\vec{I}_{b}=Σⱼ\vec{I}_{Bank}_{_{—}}ⱼwhere the absolute∠θ′_{b}=φ_{bn}+θ_{bn} (16)

\vec{I}_{c}=Σₖ\vec{I}_{Bank}_{_{—}}ₖwhere the absolute∠θ′_{c}=φ_{cn}+θ_{cn} (17)

\vec{V}ₐₙ=\vec{V}_{Bank}_{_{—}}ᵢ for any bank i that is connected between \vec{V}ₐₙ (18)

\vec{V}_{bn}=\vec{V}_{Bank}_{_{—}}ⱼ for any bank j that is connected between \vec{V}_{bn} (19)

\vec{V}_{cn}=\vec{V}_{Bank}_{_{—k}}ₖ for any bank k that is connected between \vec{V}_{cn} (20)

By applying Kirchoff's laws, we are able gain additional information about the resulting three phase circuit.

\vec{I}ₐ\vec{I}_{b}+\vec{I}_{c}=\vec{I}ₙ\vec{I}ₙ=0 when the loads are balanced (21)

and

\vec{V}ₐₙ+\vec{V}_{bn}+\vec{V}_{cn}=0 (22)

In equations (15), (16) and (17), we are able to calculate the relative angle θₗₙ for each \vec{I}ₗₙ. However, equation (21) requires a vector that is referenced to an absolute zero degrees. As such, the angles θ′ₗₙ, have been defined for each \vec{I}ₗₙ with respect to the absolute φₗₙ.

### Phase Angles

Recalling that φₐₙ=0° by definition, φ_{bn} and φ_{cn} must be measured or approximated.

### Measuring φₗₙ

Measuring φ is fairly straight-forward, but requires special hardware to monitor the zero-crossings of the sine wave. For example, using an analog-to-digital converter (ADC), we read the instantaneous value of Vₐₙ. When this value crosses the X-axis (i.e. equals zero) and the last value was above the X-axis (i.e. positive), then the waveform is said to have a “negative” slope and a zero-crossing has occurred. The frequency (in Hertz) of the sine wave can be determined by dividing one by the amount of time between zero-crossings on the same wave. The phase shift between Vₐₙ and its related waves V_{bn} and V_{cn} can be found by dividing one by the amount of time between a zero-crossing of Vₐₙ and a zero-crossing of V_{bn} or V_{cn}.

$$\begin{matrix}f = \frac{1}{\vert {t}_{a 1} - {t}_{a 2} \vert} \\ where {t}_{a 1} and {t}_{a 2} are consecutive measurements of {V}_{an} & ( 23 ) \\ {φ}_{bn} = 360 ° \times f \times [ {t}_{a 1} - {t}_{b 1} ] where {t}_{b 1} occurs before {t}_{a 2} & ( 24 ) \\ {φ}_{cn} = 360 ° \times f \times [ {t}_{a 1} - {t}_{c 1} ] where {t}_{c 1} occurs before {t}_{a 2} & ( 25 )\end{matrix}$$

In the system described in the hereinbefore referenced Verges '881 U.S. patent application, measuring these zero-crossings can be accomplished at the Network Interface Card (NIC) interface if each bank assembly notifies the NIC at its zero-crossing. Because the NIC 1510 provides a constant time reference apart from each bank assembly, it is able to make the calculations described in Equations (23), (24) and (25).

### Estimating φₗₙ

φ may also be approximated since it is a very tightly controlled fundamental parameter of three phase sources. Table 1 and Table 2 recommend values of φ.

TABLE 1
Table 1 - Estimated Values of φₗₙ for abc “Positive” Sequence

| ∠ | Value |
|---|---|
| φₐₙ | 0° |
| φ_{bn} | −120° |
| φ_{cn} | −240° |

TABLE 2
Estimated Values of φₗₙ for acb “Negative” Sequence

| ∠ | Value |
|---|---|
| φₐₙ | 0° |
| φ_{bn} | −240° |
| φ_{cn} | −120° |

Any error in φₗₙ results in an error of \vec{I}ₗₙ. The individual vectors \vec{I}ₐ, \vec{I}_{b} and \vec{I}_{c} will not be affected since they are calculated with respect to their voltage vectors \vec{V}ₗₙ.

### Three Phase Delta Circuits

Calculating the Line Currents

Referring now to FIG. 23 and FIG. 24, in a Delta system, each bank is connected between two pairs of the lines (A, B or C).

\vec{V}_{ab}=\vec{V}ₐₙ−\vec{V}_{bn}where \vec{V}_{ab}=\vec{V}_{Bank}_{_{—}}ᵢ for any bank i connected between \vec{V}_{ab} (26)

\vec{V}_{bc}=\vec{V}_{bn}−\vec{V}_{cn}where \vec{V}_{bc}=\vec{V}_{Bank}_{_{—}}ⱼ for any bank j connected between \vec{V}_{bc} (27)

\vec{V}_{ca}=\vec{V}_{cn}−\vec{V}ₐₙwhere \vec{V}_{ca}=\vec{V}_{Bank}_{_{—}}ₖ for any bank k connected between \vec{V}_{ca} (28)

See Equation (43) for a method to estimate \vec{V}ₗₙ if it is not measured.

Though we measure Iₗₗ, determining the line currents is much more difficult. Arthur Edwin Kennelly in “Equivalence of triangles and stars in conducting networks”, Electrical World and Engineer, Volume 34, pp 413-414 in 1899 proposed a set of equations to convert the Delta system to a Wye system, which is simpler to solve. To compute Iₗₙ, st we must transform the Delta-based Iₗₗ into its Wye-based equivalent. This is accomplished by using the resistance of each load.

$$\begin{matrix}{R}_{ab} = \frac{{V}_{ab}}{{I}_{ab}} & ( 29 ) \\ {R}_{bc} = \frac{{V}_{bc}}{{I}_{bc}} & ( 30 ) \\ {R}_{ca} = \frac{{V}_{ca}}{{I}_{ca}} & ( 31 ) \\ {R}_{an} = \frac{{R}_{ab} \times {R}_{ca}}{{R}_{ab} + {R}_{bc} + {R}_{ca}} & ( 32 ) \\ {R}_{bn} = \frac{{R}_{bc} \times {R}_{ab}}{{R}_{ab} + {R}_{bc} + {R}_{ca}} & ( 33 ) \\ {R}_{cn} = \frac{{R}_{ca} \times {R}_{bc}}{{R}_{ab} + {R}_{bc} + {R}_{ca}} & ( 34 )\end{matrix}$$

The current on each line can then be calculated using the conservation of apparent power.

$$\begin{matrix}{I}_{an} = \frac{{V}_{an}}{{R}_{an}} & ( 35 ) \\ {I}_{bn} = \frac{{V}_{bn}}{{R}_{bn}} & ( 36 ) \\ {I}_{cn} = \frac{{V}_{cn}}{{R}_{cn}} & ( 37 )\end{matrix}$$

Unfortunately, Kennelly's equations assume that current exists in each line-to-line connection. As Iₗₗ approaches zero, the resistance Rₗₗ approaches infinity. If the line-to-line load is severely unbalanced (meaning that Iₗₗ is not split evenly between its two line-line-to-neutral components), there is no good od solution other than to measure the line currents individually. Blondel's Theorem indicates how many measurements will need to be made: N−1 where N is the number of lines.

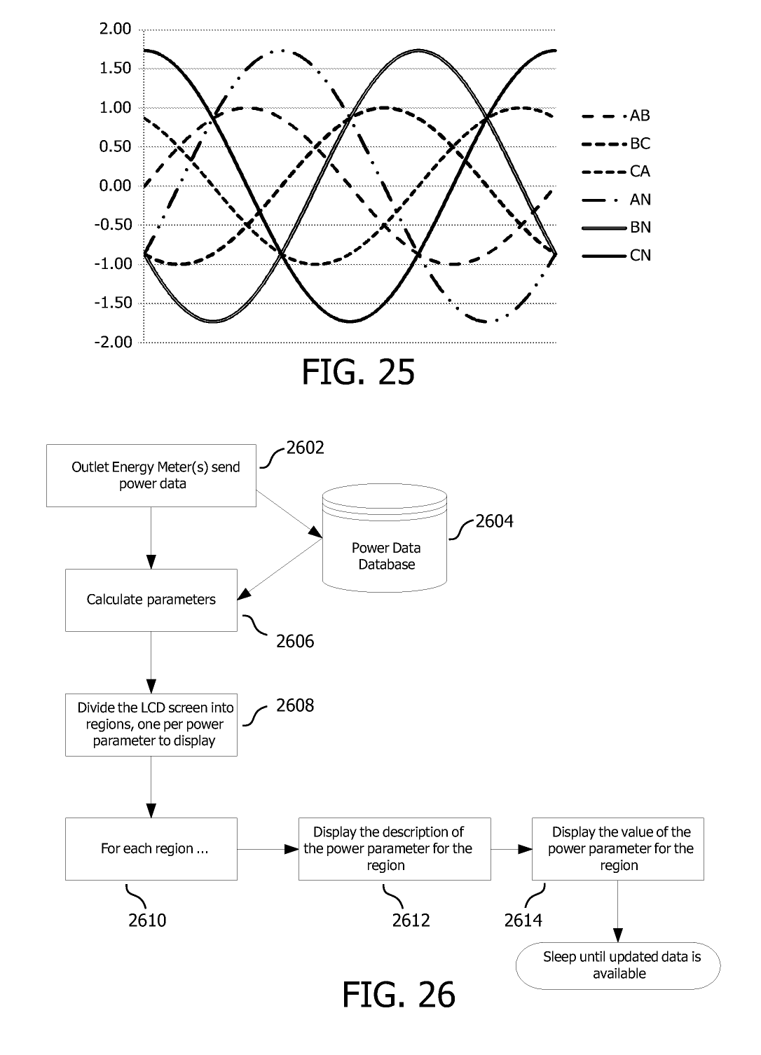

It may be adequate to assume that Iₗₗ splits evenly. In this case, the line currents may be calculated using Equations (38), (39) and (40). FIG. 25 visualizes the complex interaction between the line-to-line currents and the line-to-neutral currents (the waves with larger peaks are the line-to-neutral currents.)

\vec{I}ₐₙ=\vec{I}_{ab}−\vec{I}_{ca} (38)

\vec{I}_{bn}=\vec{I}_{bc}−\vec{I}_{ab} (39)

\vec{I}_{cn}=\vec{I}_{ca}−\vec{I}_{bc} (40)

### Phase Angles

Like in the previous section on Wye circuits, φ plays a critical role in determining information here. In addition to the line-to-neutral φ that was described, we must also consider the line-to-line φ. We are faced with a choice of calculating, measuring or estimating φₗₗ.

Calculating φₗₗ from φₗₙ

If one measures φₗₙ and Vₗₙ, then φₗₗ can be calculated very accurately using vector addition. See equations (26)(26), (27) and (28).

### Measuring φₗₗ

Like φₗₙ, φₗₗ can be measured by calculating the time difference in zero-crossings of the voltage waves Vₗₗ.

φ′ₗₗ=360°×f×[tₓ₁−t_{y1}] (41)

This time difference will result in φ′ₗₗ, also known as the relative offset of φₗₗ. To calculate Vₗₗ, we need the difference in the relative offset and the absolute offset.

φ_{offset}=φₗₗ−φ′ₗₗ (42)

This offset can either be measured (by comparing the zero-crossings of Vₐₙ and V_{ab}) or estimated to thirty degrees for an abc sequence or minus thirty degrees for an acb sequence.

### Estimating φₗₗ

We can take advantage of the real-world commonality between most three phase systems and estimate φ. If we assume that the voltage in all Vₗₗ is balanced within an acceptable threshold, then we can approximate a common voltage V_{zn} as described in Equation (43).

$${V}_{zn} = \frac{1}{\sqrt{3}} [ \frac{{V}_{ab} + {V}_{bc} + {V}_{ca}}{3} ] \qquad ( 43 )$$

V_{zn} can then be used to describe Vₐₙ, V_{bn} and Vₗₙ. Because Vₗₙ is then equal, φₗₙ is then equal to the values presented in Tables 1 and 2. φₗₗ can also be approximated using Table 3 and Table 4.

TABLE 3
Estimated Values of φₗₗ for abc “Positive” Sequence

| ∠ | Value |
|---|---|
| φ_{ab} | 30° |
| φ_{bc} | −90° |
| φ_{ca} | −210° |

TABLE 4
Estimated Values of φₗₗ for acb “Negative” Sequence

| ∠ | Value |
|---|---|
| φ_{ab} | −30° |
| φ_{bc} | −150° |
| φ_{ca} | −270° |

### Three Phase Wye

As an example, we calculate the individual line information for a three phase power distribution unit that contains twelve outlets, three banks, and one three phase input cord. For this example, assume that the outlets are evenly distributed across the banks; that is, four outlets per bank. Table 5 presents the measured outlet data.

TABLE 5
Example Outlet Data for Three Phase Wye PDU

| Bank | Outlet | V | I | θ |
|---|---|---|---|---|
| 1 | 1 | 120 | 1 | 0° |
| | 2 | | 2 | 10° |
| | 3 | | 0 | 20° |
| | 4 | | 3 | −10° |
| 2 | 5 | 117 | 4 | −30° |
| | 6 | | 8 | −20° |
| | 7 | | 2 | 60° |
| | 8 | | 1 | 10° |
| 2 | 9 | 112 | 5 | 80° |
| | 10 | | 2 | 30° |
| | 11 | | 3 | −45° |
| | 12 | | 6 | −20° |

We now can find:

\vec{P}_{Bank1}≈711∠0°W from Equation (4)

\vec{Q}_{Bank1}≈21∠−90°VAR from Equation (5)

S_{Bank1}≈711VA from Equation (6)

$${θ}_{Bank 1} = {tan}^{- 1} ( \frac{- 21 VAR}{711 W} ) \approx - 2 °$$

I_{Bank1}≈6A from Equation (7)

\vec{P}_{Bank2}≈1,517∠0°W

\vec{Q}_{Bank2}≈331∠−90°VAR

S_{Bank2}≈1,553VA

$${θ}_{Bank 2} = {tan}^{- 1} ( \frac{- 331 VAR}{1 , 517 W} ) \approx - 12 °$$

I_{Bank2}≈13A

\vec{P}_{Bank3}≈1,264∠0°W

\vec{Q}_{Bank3}≈214∠90°VAR

S_{Bank3}≈1,282VA

$${θ}_{Bank 3} = {tan}^{- 1} ( \frac{- 214 VAR}{1 , 264 W} ) \approx 9 °$$

I_{Bank3}≈11A

\vec{V}ₐₙ=120∠0° from Equation (18) and Table??

\vec{I}ₐ=6∠−2° from Equation (15)

\vec{V}_{bn}=117∠−120° from Equation (19) and Table ??

\vec{I}_{b}=13∠−12° from Equation (16)

\vec{V}_{cn}=122∠−240° from Equation (20) and Table??

\vec{I}_{c}=\vec{I}_{Bank3}=11∠2° from Equation (17)

### Three Phase Delta

Next we calculate the individual line information for a three phase power distribution unit that contains twelve outlets, three banks, and one three phase input cord. Assume that the outlets are evenly distributed across the banks; that is, four outlets per bank. Table 6 contains the measured outlet data.

TABLE 6
Example Outlet Data for Three Phase Delta PDU

| Bank | Outlet | V | I | θ |
|---|---|---|---|---|
| 1 | 1 | 207 | 1 | 0° |
| | 2 | | 2 | 10° |
| | 3 | | 0 | 20° |
| | 4 | | 3 | −10° |
| 2 | 5 | 211 | 4 | −30° |
| | 6 | | 8 | −20° |
| | 7 | | 2 | 60° |
| | 8 | | 1 | 10° |
| 2 | 9 | 209 | 5 | 80° |
| | 10 | | 2 | 30° |
| | 11 | | 3 | −45° |
| | 12 | | 6 | −20° |

Now we can find:

\vec{P}_{Bank1}≈1,226∠0°W from Equation (4)

\vec{Q}_{Bank1}≈36∠−90°VAR from Equation (5)

S_{Bank1}≈1,227VA from Equation (6)

$${θ}_{Bank 1} = {tan}^{- 1} ( \frac{- 36 VAR}{1 , 226 W} ) \approx - 2 °$$

I_{Bank1}≈6A from Equation (7)

\vec{P}_{Bank2}≈2,736∠0°W

\vec{Q}_{Bank2}≈597∠−90°VAR

S_{Bank2}≈2,800VA

$${θ}_{Bank 2} = {tan}^{- 1} ( \frac{- 597 VAR}{2 , 736 W} ) \approx - 12 °$$

I_{Bank2}≈13A

\vec{P}_{Bank3}≈2,165∠0°W

\vec{Q}_{Bank3}≈367∠90°VAR

S_{Bank3}≈2,196VA

$${θ}_{Bank 3} = {tan}^{- 1} ( \frac{367 VAR}{2 , 165 W} ) \approx 9 °$$

I_{Bank3}≈11A

Since the voltages on all the banks are relatively close, we can use Equation (43) to estimate the line-to-neutral voltages and phase angles.

\vec{V}ₐₙ≈121∠0° from Equation (43) and Table 1

\vec{V}_{bn}≈121∠−120° from Equation (43) and Table 1

\vec{V}_{cn}≈121≈−240° from Equation (43) and Table 1

Assuming that the resistance of the line-to-line loads are roughly equal, we can estimate the current in each line.

\vec{I}ₐₙ≈15∠0° from Equation (38) and Table 3

\vec{I}_{bn}≈10∠−120° from Equation (39) and Table 3

\vec{I}_{cn}≈19∠−240° from Equation (40) and Table 3

The results of the above-described method may be displayed on the touch screen 108, stored into a database, or both. Looking to FIG. 26, outlet energy meters 1300 send their data to the NIC 1510 via the CAN data link, as previously described 1602. The NIC 1510 saves the data into a power data database 2604. The database is stored in a mass storage device, for example a hard disc drive, or in other embodiments is stored in electronic memory, or both. The NIC then performs the above-described calculations 2606. The data may optionally then be displayed to a viewer on a touch screen 108 or remotely on a monitor, either periodically or upon request. For an example wherein the data is presented on a touch screen 108, the screen is divided into regions to display individual parametric data 2608. Then for each region 2610 the description of the parameter 2612 and the value of the data found 2614 are displayed. The display may then sleep 2616 for a predetermined time, rerun upon request by the NIC 1510, request by a viewer, request by a remote system, and the like.

### RESOLUTION OF CONFLICTS

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

We claim:

1. A power distribution unit, comprising:
a microprocessor;
a display device electrically connected with the microprocessor; and
at least one energy metering and control board electrically connected to the microprocessor, wherein each of the at least one energy metering and control boards provides electrical power to a one or more electrical outlet.

2. The power distribution unit of claim 1, further comprising a speaker electrically connected to the microprocessor.

3. The power distribution unit of claim 1, further comprising a microphone electrically connected to the microprocessor.

4. The power distribution unit of claim 1, further comprising a camera electrically connected to the microprocessor.

5. The power distribution unit of claim 1, further comprising communications means electrically connected to the microprocessor, thereby forming a network interface unit.

6. The power distribution unit of claim 5, wherein the communications means is a USB host port.

7. The power distribution unit of claim 5, wherein the communications means is a wireless transceiver.

8. The power distribution unit of claim 5, wherein the communications means is an Ethernet connection.

9. The power distribution unit of claim 1, wherein the display is a liquid crystal display.

10. The power distribution unit of claim 1, wherein the display is a monitor.

11. The power distribution unit of claim 10, wherein the monitor is a QVGA.

12. The power distribution unit of claim 1, wherein the display includes a human input device.

13. The power distribution unit of claim 12, wherein the human input device is a touch screen.

14. The power distribution unit of claim 1, wherein the energy metering and control board includes means for measuring the value of a parameter of a given electrical outlet of the one or more electrical outlets.

15. The power distribution unit of claim 14, wherein the parameter is the apparent power of a given outlet.

16. The power distribution unit of claim 14, wherein the parameter is the real power of a given electrical outlet.

17. The power distribution unit of claim 14, wherein each energy metering and control board further comprises communication means and a controller electrically connected to the means for measuring a parameter of the power of a given electrical outlet, wherein the controller receives data corresponding to the parameter from the measuring means and provides the data to the communication means.

18. The power distribution unit of claim 17, wherein the communications means comprises a CAN transceiver.

19. The power distribution unit of claim 17, wherein the communications means is further operatively connected to the communications means of one or more other energy metering and control board.

20. The power distribution unit of claim 1, wherein each energy metering and relay board includes means for turning a given electrical outlet of the one or more electrical outlets ON and OFF.

21. A processor programmed to characterize a Wye-configured three phase power grid wherein each phase provides electrical power to a plurality of electrical outlets and wherein each plurality of electrical outlets forms an outlet bank, the program method comprising the steps of:
receiving power data for each outlet in each bank from an energy measuring device wherein said power data comprises real power, voltage, and current;
aggregating the data from all outlets in each bank by summing reactive power and real power of all outlets in the bank;
further aggregating the bank power data into power data for each of three lines in the Wye-configured power grid by summing the reactive power and the real power of each bank connected to each line.

22. The processor of claim 21, wherein the power data further comprises frequency and absolute phase shift.

23. A processor programmed to characterize a Delta-configured three phase power grid wherein each pair of phases provides electrical power to a plurality of electrical outlets and wherein each plurality of electrical outlets forms an outlet bank, the program method comprising the steps of:
receiving power data for each outlet in each bank from an energy measuring device wherein said power data comprises real power, voltage, and current;
aggregating the data from all outlets in each bank by summing reactive power and real power of all outlets in the bank;
further aggregating the bank power data into power data for each of three lines in the Delta-configured power grid by proportionally scaling and then summing the current consumed in each bank connected to the line in question.

24. The processor of claim 23, wherein the power data further comprises frequency and absolute phase shift.
